(19) United States
(12) Patent Application Publication
(10) Pub. No.: US 2016/0251830 A1
(43) Pub. Date: Sep. 1, 2016

(54) HYDRAULIC SYSTEM OF CONSTRUCTION EQUIPMENT, HAVING FLOAT FUNCTION

(71) Applicants: Young-Jin SON, Changwon-si Gyeongsangnam-do (KR); Jun JO, Changwon-si Gyeongsangnam-do (KR); VOLVO CONSTRUCTION EQUIPMENT AB, Eskilstuna (SE)

(72) Inventors: Young-Jin SON, Changwon-si (KR); Jun JO, Changwon-si (KR)

(21) Appl. No.: 15/032,686

(22) PCT Filed: Oct. 30, 2013
(86) PCT No.: PCT/KR2013/009751

§ 371 Date: Apr. 28, 2016

(51) Int. Cl. E02F 9/22; E02F 3/42; F15B 11/028; E02F 3/84

(52) U.S. Cl. CPC E02F 9/2203; E02F 3/844; E02F 9/2285; E02F 3/425; F15B 11/028; E02F 3/32

(57) ABSTRACT

A hydraulic system of construction equipment having a float function is disclosed, which includes a hydraulic pump and a pilot pump supplying hydraulic fluid to drive a working device; a remote control valve outputting a pilot signal corresponding to an operation amount of an operation lever; a hydraulic cylinder connected to the hydraulic pump; a main control valve installed in a discharge flow path of the hydraulic pump to control a start, stop, and direction change of the hydraulic cylinder when a spool is shifted; a solenoid valve shifted to an opening position when a float function switch is turned on; and a two-stage port relief valve installed in a flow path between the main control valve and the hydraulic cylinder, and shifted to return the hydraulic fluid in a large chamber of the hydraulic cylinder to a hydraulic tank so that the working device moves down when the float function switch is turned on.

### TECHNICAL FIELD

The present invention relates to a hydraulic system of construction equipment having a float function, and more particularly, to a hydraulic apparatus for a construction machine having a float function, which can reduce the number of hydraulic elements and manufacturing cost by making a working device down without a float valve when a float function switch is operated to perform leveling or grading work at a construction site.

### BACKGROUND OF THE INVENTION

Typically, a construction machine such as an excavator or a dozer may be used to perform leveling or grading work at a construction site. The excavator may be driven to make a boom down so that a bucket comes in contact with the ground, and the dozer equipment may be driven to make a dozer blade device that is mounted on an arm or a tilt arm come in contact with the ground.

As one of the related arts, Korean Patent Application Publication No. 2010-0134827 discloses a hydraulic system for a construction machine capable of implementing a float function that makes it possible to perform leveling or grading work.

According to the above-described hydraulic system in the related art, in order to perform the leveling work using an excavator, a logic poppet for performing a holding function is provided inside a float valve, and float and holding valves are unified to simplify the structure of the valves and hydraulic pipes connecting the valves to each other.

However, the above-described hydraulic system in the related art requires a separate float valve for the float function, and it is necessary to construct the float valve between the hydraulic cylinder of a working device and a hydraulic control valve.

Accordingly, a hydraulic circuit that is required to perform the float function becomes complicated, and this causes the number of hydraulic elements and manufacturing cost to be increased.

Even in the case of the dozer equipment, a float valve that is installed between the hydraulic cylinder of a dozer blade and the hydraulic control valve of a working device is driven when a float function switch is operated, and thus the dozer blade moves down to come in contact with the ground for the leveling or grading work.

Accordingly, it is essentially required to construct the float valve between the working device, such as the boom cylinder or the dozer blade cylinder, and the hydraulic control valve when the construction machine, such as the excavator or the dozer, performs the float function, and this causes the number of hydraulic elements related to the float valve and the manufacturing cost thereof to be increased.

### SUMMARY OF THE INVENTION

Accordingly, the present invention has been made to solve the aforementioned problems occurring in the related art, and one subject to be achieved by the present invention is to provide a hydraulic apparatus for a construction machine having a float function, which makes it possible to manufacture compact hydraulic circuit and hydraulic pipe at reduced manufacturing cost by performing a float function of a working device including a boom or a dozer blade without a float valve.

Another subject to be achieved by the present invention is to provide a hydraulic apparatus for a construction machine having a float function, which can effectively perform a float function of a working device by opening a flow path for making the working device down through a pilot signal that is output through a remote control valve when the float function is performed and making hydraulic fluid of a hydraulic cylinder return to a hydraulic tank.

### Technical Solution

To achieve the above and other subjects, in accordance with an embodiment of the present invention, there is provided a hydraulic apparatus for a construction machine having a float function, which includes a hydraulic pump and a pilot pump supplying hydraulic fluid to drive a working device; a remote control valve outputting a pilot signal corresponding to an operation amount of an operation lever; a working device hydraulic cylinder connected to the hydraulic pump; a main control valve installed in a discharge flow path of the hydraulic pump to control a start, stop, and direction change of the hydraulic cylinder when a spool is shifted; a solenoid valve shifted to an opening position when a float function switch is turned on; and a two-stage port relief valve installed in a flow path between the main control valve and the working device hydraulic cylinder, and shifted to return the hydraulic fluid in a large chamber of the hydraulic cylinder to a hydraulic tank so that the working device descends when the float function switch is operated to be turned on.

The hydraulic cylinder can be composed of a boom cylinder, and the two-stage port relief valve can include a signal pressure port into which pilot signal pressure is introduced through the remote control valve when the float function switch is operated to effectively perform the float function.

The hydraulic cylinder can be composed of a hydraulic cylinder for a dozer blade device to effectively perform the float function of dozer equipment.

The two-stage port relief valve can be set to a minimum relief pressure state by the pilot signal pressure to open an inner flow path thereof, and thus the hydraulic fluid in the hydraulic cylinder for the boom or the dozer blade device can return to the hydraulic tank to perform the float function.

In accordance with another embodiment of the present invention, there is provided a hydraulic apparatus for a construction machine having a float function, which includes a hydraulic pump and a pilot pump supplying hydraulic fluid to drive a working device; a remote control valve outputting a pilot signal corresponding to an operation amount of an operation lever; a working device hydraulic cylinder connected to the hydraulic pump; a main control valve installed in a discharge flow path of the hydraulic pump to control a start, stop, and direction change of the hydraulic cylinder when a spool is shifted; a solenoid valve shifted to an opening position when a float function switch is turned on; and an on-off check valve installed in a flow path between the main control valve and the working device hydraulic cylinder, and shifted to return the hydraulic fluid in a small chamber of the hydraulic cylinder to a hydraulic tank so that the working device descends when the float function switch is operated.

### Advantageous Effect

According to the hydraulic apparatus for a construction machine having a float function according to the present invention, when the float function is inactivated, the maximum relief pressure is maintained, whereas when the float function is activated, the inner flow path of the 2-stage port relief valve is opened by the pilot signal that is output through the remote control valve to make the hydraulic fluid in the hydraulic cylinder of a working device return to the hydraulic tank, and thus the leveling or grading work using the working device can be effectively performed.

According to the hydraulic apparatus for a construction machine having a float function according to the present invention, the float function of the working device including the boom or the dozer blade is performed without the float valve, and thus it becomes possible to design compact hydraulic circuit and hydraulic pipe and to save the manufacturing cost.

### BRIEF DESCRIPTION OF THE DRAWINGS

The above subjects, other features and advantages of the present invention will become more apparent by describing the preferred embodiments thereof with reference to the accompanying drawings, in which:

FIG. 1 is a schematic hydraulic circuit diagram of a hydraulic apparatus for a construction machine having a float function according to an embodiment of the present invention;

FIG. 2 is a schematic hydraulic circuit diagram of a hydraulic apparatus for a construction machine having a float function according to another embodiment of the present invention;

FIG. 3 is a diagram of a main part of a hydraulic apparatus for a construction machine having a float function according to still another embodiment of the present invention; and

FIG. 4 is a schematic perspective view of an excavator provided with a hydraulic apparatus for a construction machine having a float function according to the present invention.

### DETAILED DESCRIPTION OF THE INVENTION

The terms or wordings used in the description and claims could be used as meanings commonly understood by those ordinary skilled in the art to which the present invention belongs. In addition, the terms or wordings that are generally used but are not defined in the dictionary are not interpreted ideally or excessively unless they have been clearly and specially defined.

Hereinafter, preferred embodiments of the present invention will be described in detail with reference to the accompanying drawings.

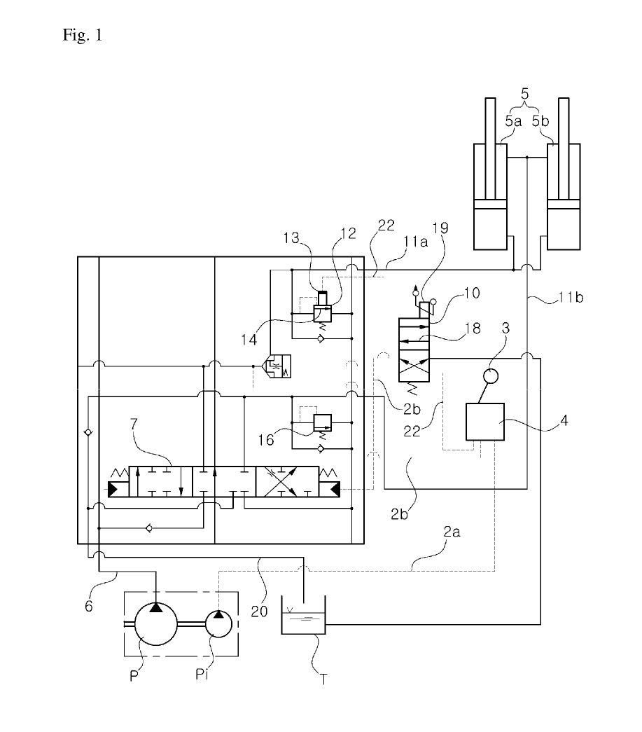

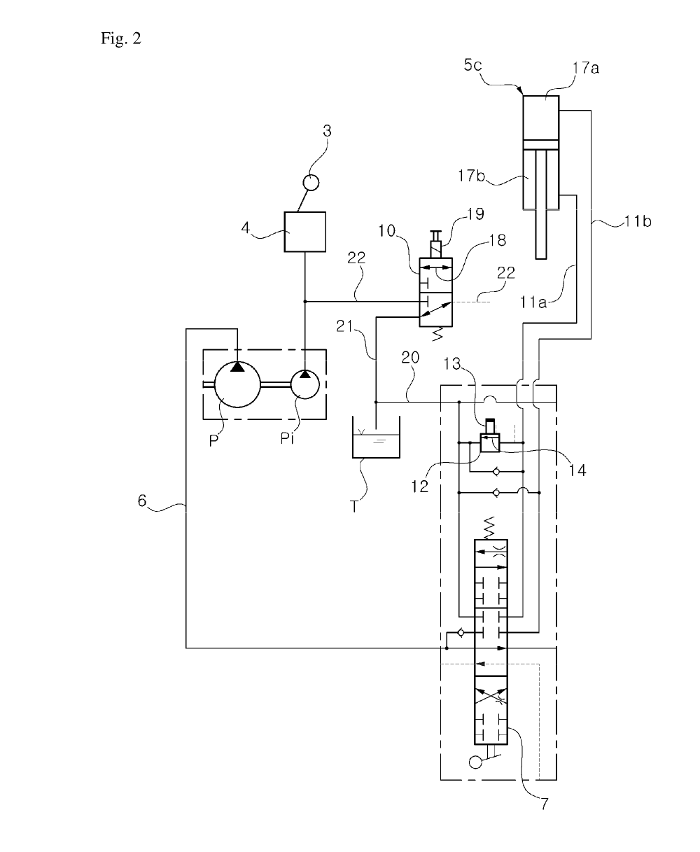

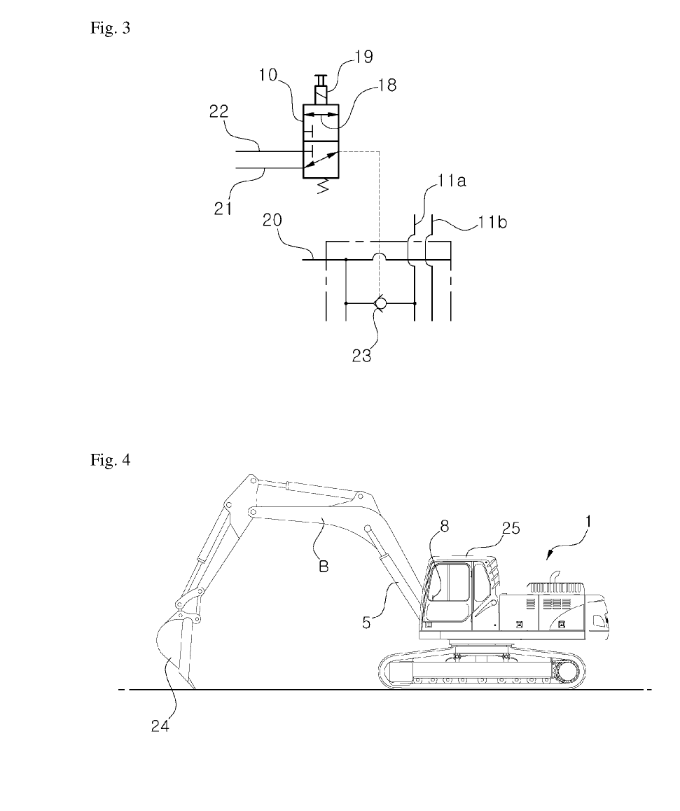

FIG. 1 is a schematic hydraulic circuit diagram of a hydraulic apparatus for a construction machine having a float function according to an embodiment of the present invention, and FIG. 2 is a schematic hydraulic circuit diagram of a hydraulic apparatus for a construction machine having a float function according to another embodiment of the present invention. FIG. 3 is a diagram of a main part of a hydraulic apparatus for a construction machine having a float function according to still another embodiment of the present invention, and FIG. 4 is a schematic perspective view of an excavator provided with a hydraulic apparatus for a construction machine having a float function according to the present invention.

In the drawings, the drawing reference numeral “1” denotes an excavator according to an embodiment of the present invention, “3” denotes an operation lever, “4” denotes a remote control valve, “5” denotes a hydraulic cylinder of a working device that is driven when a float function is activated, “10” denotes a solenoid valve, and “12” denotes a 2-stage port relief valve.

The hydraulic apparatus for a construction machine having a float function according to the present invention is applied to an excavator that performs leveling or grading work to level the ground or a construction machine that includes a dozer or a grader, and performs floating operation to make a working device approach the ground in accordance with activation of the float function.

More specifically, referring to FIG. 1, a hydraulic apparatus for a construction machine having a float function according to an embodiment of the present invention includes a hydraulic pump 1 and a pilot pump 2 supplying hydraulic fluid to drive a working device; a remote control valve 4 outputting a pilot signal corresponding to an operation amount of an operation lever 3; a hydraulic cylinder of a working device 5 connected to the hydraulic pump 1; and a main control valve 7 installed in a discharge flow path 6 of the hydraulic pump 1 to control a start, stop, and direction change of the hydraulic cylinder 5 when a spool is shifted.

In an excavator, the main control valve 7 may have a plurality of hydraulic control valves built therein to drive a working device, such as a bucket or an arm.

The working device hydraulic cylinder 5 may include a pair of hydraulic cylinders 5a and 5b to perform up and down of a boom, and in the case of dozer equipment, a dozer blade that is required for the float operation may include a hydraulic cylinder 5c. This will be described in more detail later.

In a construction machine including the excavator or the dozer as described above, a float function switch 8 may be provided in a cab, and if an operator operates the switch, an electrical signal or a pilot signal for controlling opening and closing of the valve that is required to perform the float function may be output from the float function switch 8.

A solenoid valve 10 is shifted to an opening position when the float function switch 8 is turned on, and is shifted to a closing position when the float function switch 8 is turned off.

This will be understood that if the operator turns on the float function switch 8, the float function is activated, whereas if the operator turns off the float function switch 8, the float function is inactivated.

Preferably, the solenoid valve 10 is configured to include a signal pressure port 19 into which a valve control signal is introduced when the float function switch 8 is operated to open or close the valve, and an inner flow path 18 for connecting pilot signal pressure that is provided through the remote control valve 4.

The hydraulic apparatus for a construction machine having a float function according to an embodiment of the present invention further includes a two-stage port relief valve 12 installed in a flow path 11 between the main control valve 7 and the working device hydraulic cylinder 5, and shifted to return the hydraulic fluid in a large chamber of the hydraulic cylinder 5 to a hydraulic tank 15 so that the working device descends when the float function switch 8 is operated to be turned on.

The 2-stage port relief valve 12 includes a signal pressure port 13 into which the pilot signal pressure is introduced through the remote control valve 4 when the float function switch 8 is operated.

Preferably, the 2-stage port relief valve 12 is shifted to open the inner flow path 14 in a state where the minimum relief pressure is set by the pilot signal pressure when the float function for the working device is performed or activated, and thus the hydraulic fluid of the hydraulic cylinder 5 returns to the hydraulic tank 15.

This will be understood that the valve opening ratio of the 2-stage port relief valve 12 may be changed to the minimum relief pressure state by the valve control signal that is provided from an outside, for example, the pilot signal pressure.

In contrast, if the float function is unnecessary and the working device is operated in an inactivated state, for example, if the operator drives the working device without operating the float function switch 8, the 2-stage port relief valve 12 is maintained in the predetermined maximum relief pressure state, and thus the inner flow path 14 is closed.

On the other hand, a relief valve 16 may be further installed to drain hydraulic pressure between the hydraulic cylinder 5 and the main control valve 7 to the hydraulic tank 15 if the hydraulic pressure exceeds predetermined system pressure when the working device ascends or descends.

FIG. 2 is a hydraulic circuit diagram explaining a state where a hydraulic apparatus for a construction machine having a float function according to another embodiment of the present invention is applied to dozer equipment.

Referring to FIG. 2, in the case of a dozer blade working device according to the present invention, the 2-stage port relief valve 10 is installed in the flow path 11 between the main control valve 7 and the working device hydraulic cylinder 5, and if the float function switch 8 is operated in a neutral position of the main control valve 7, the 2-stage port relief valve 10 is shifted to return the hydraulic fluid of the hydraulic cylinder 5 to the hydraulic tank 15 in response to the pilot signal pressure that is provided through the solenoid valve 10.

In various embodiments of the present invention, the solenoid valve 10 may be operated to provide the pilot signal pressure for opening or closing the valve when the float function switch 8 is operated in the neutral position of the main control valve 7.

Referring to FIG. 3, the hydraulic apparatus for a construction device having a float function according to the present invention includes an on-off check valve 23 installed in a flow path 11a or 11b between the main control valve 7 and the working device hydraulic cylinder 5c, and shifted to return the hydraulic fluid of the hydraulic cylinder 5c to the hydraulic tank 15 so that the working device descends when the float function switch 8 is operated.

The hydraulic cylinder 5c is used for up/down or tilt driving of the dozer blade.

In various embodiments of the present invention, the two-stage port relief valve 12 or the on-off check valve 23 may be variously applied to return the hydraulic fluid of the large chamber 17a or the small chamber 17b of the hydraulic cylinder 5, which is required in accordance with the working device, to the hydraulic tank 15.

Hereinafter, the operation principle of the hydraulic apparatus for a construction machine having a float function according to the present invention will be described.

In the case where the float function is inactivated, the operator may control the driving of a working device including a boom B after turning off the float function switch 8.

For example, if the operator operates the operation lever 3 to control the remote control valve 4 in a state where the float function is inactivated, pilot hydraulic fluid that is discharged from a pilot pump Pi is supplied to the main control valve 7 through a pilot flow path 2b to shift the spool of the main control valve 7.

At this time, the hydraulic fluid that is discharged from the hydraulic pump 1 is supplied to the large chamber and the small chamber of the hydraulic cylinder 5 through the discharge flow path 6 and the main control valve 7 to drive the working device. In this case, the 2-stage port relief valve 12 according to the present invention is maintained in the predetermined maximum relief pressure state, and the inner flow path 14 is closed to maintain the valve close state.

In the hydraulic circuit for an excavator according to an embodiment of the present invention, the hydraulic fluid is supplied to the pair of hydraulic cylinders 5a and 5b to drive the boom, but in the case of other working devices that require the float function, the hydraulic cylinder 5c may be independently operated.

In the case where the float function is activated according to the present invention, the main control valve 7 is positioned in the neutral state, and the boom working device or the dozer blade working device may descend to approach the ground in accordance with the operation of the float function switch 8.

For example, in the case where the leveling work or the grading work is required at the construction site, as illustrated in FIG. 4, the operator operates the float function switch 8 that is installed inside the cab 25 to perform the float function.

More specifically, referring to FIG. 1, in a neutral state of the main control valve 7, the pilot hydraulic fluid that is discharged from the pilot pump 2 is supplied to a signal pressure flow path 22 through the remote control valve 4. At this time, if the float function switch 8 is operated, the electrical signal or the pilot signal for opening or closing the valve is applied to the signal pressure port 19 of the solenoid valve 10, and thus the solenoid valve 10 is shifted to the opening position of the inner flow path 18.

The signal pressure of the pilot hydraulic fluid that is supplied to the signal pressure flow path 22 through the remote control valve 4 is provided to the inner flow path 14 of the 2-stage port relief valve 12 through the inner flow path 18 of the solenoid valve 10. The inner flow path 14 of the 2-stage port relief valve 12 is shifted to the opening position by the pressure of the pilot hydraulic fluid that is supplied to the signal pressure port 13.

In this case, the hydraulic pressure of the working device hydraulic cylinder 5 in the neutral position of the main control valve 7 returns to the hydraulic tank 15 through a return flow path 20, and thus the boom working device descends to approach the ground so that a bucket 24 perform the leveling and grading work.

Here, in the case where the hydraulic apparatus for a construction machine having a float function according to the present invention is applied to the dozer equipment, as illustrated in FIG. 2, the hydraulic fluid of the dozer blade hydraulic cylinder 5c returns to the hydraulic tank 15 through the return flow path 20 in the neutral position of the main control valve 7, and thus the dozer blade working device descends to approach the ground to perform the leveling and grading work or grading work.

In an embodiment of the present invention, the on-off check valve 23 may be constructed instead of the 2-stage port relief valve 12. In this case, as illustrated in FIG. 3, if the float function switch 8 is operated to be turned on, the signal pressure of the pilot hydraulic fluid that is supplied to the signal pressure flow path 22 through the remote control valve 4 is supplied to the on-off check valve 23 through the inner flow path 18 of the solenoid valve 10.

Accordingly, the on-off check valve 23 is opened, and the hydraulic pressure of the working device hydraulic cylinder 5 returns to the hydraulic tank 15 through the return flow path 20 in the neutral position of the main control valve 7.

As described above, according to the hydraulic apparatus for a construction machine having a floating function according to the present invention, if the float function is activated, the 2-stage port relief valve 12 or the on-off check valve 23 returns the hydraulic pressure of the working device hydraulic cylinder to the hydraulic tank 15, and thus the float function of the working device can be smoothly performed.

Although the present invention has been described with reference to the preferred embodiment in the attached figures, it is to be understood that various equivalent modifications and variations of the embodiments can be made by a person having an ordinary skill in the art without departing from the spirit and scope of the present invention as recited in the claims.

### INDUSTRIAL APPLICABILITY

According to the hydraulic apparatus for a construction machine having a float function according to the present invention, since the float function of the boom or dozer blade working device is performed through the control of the simple hydraulic apparatus, the leveling work or the grading work that is required at the construction site can be efficiently performed.

1. A hydraulic apparatus for a construction machine having a float function, comprising:
a hydraulic pump and a pilot pump supplying hydraulic fluid to drive a working device;
a remote control valve outputting a pilot signal corresponding to an operation amount of an operation lever;
a hydraulic cylinder of the working device connected to the hydraulic pump;
a main control valve installed in a discharge flow path of the hydraulic pump to control a start, stop, and direction change of the hydraulic cylinder when a spool is shifted;
a solenoid valve shifted to an opening position when a float function switch is turned on; and
a two-stage port relief valve installed in a flow path between the main control valve and the hydraulic cylinder of the working device, and shifted to return the hydraulic fluid in a large chamber of the hydraulic cylinder to a hydraulic tank so that the working device moves down when the float function switch is operated to be turned on.

2. The hydraulic apparatus according to claim 1, wherein the hydraulic cylinder is composed of a boom cylinder, and the two-stage port relief valve comprises a signal pressure port into which pilot signal pressure is introduced through the remote control valve when the float function switch is operated.

3. The hydraulic apparatus according to claim 2, wherein the hydraulic cylinder is composed of a hydraulic cylinder for a dozer blade.

4. The hydraulic apparatus according to claim 1, wherein the two-stage port relief valve is set to a minimum relief pressure state by the pilot signal pressure to open an inner flow path thereof, and thus the hydraulic fluid in the hydraulic cylinder returns to the hydraulic tank.

5. A hydraulic apparatus for a construction machine having a float function, comprising:
a hydraulic pump and a pilot pump supplying hydraulic fluid to drive a working device;
a remote control valve outputting a pilot signal corresponding to an operation amount of an operation lever;
a working device hydraulic cylinder connected to the hydraulic pump;
a main control valve installed in a discharge flow path of the hydraulic pump to control a start, stop, and direction change of the hydraulic cylinder when a spool is shifted;
a solenoid valve shifted to an opening position when a float function switch is turned on; and
an on-off check valve installed in a flow path between the main control valve and the working device hydraulic cylinder, and shifted to return the hydraulic fluid in a small chamber of the hydraulic cylinder to a hydraulic tank so that the working device descends when the float function switch is operated.

6. The hydraulic apparatus according to claim 5, wherein the hydraulic cylinder is composed of a hydraulic cylinder for a dozer blade device.

7. The hydraulic apparatus according to claim 2, wherein the two-stage port relief valve is set to a minimum relief pressure state by the pilot signal pressure to open an inner flow path thereof, and thus the hydraulic fluid in the hydraulic cylinder returns to the hydraulic tank.
